(19) United States
(12) Patent Application Publication
(10) Pub. No.: US 2023/0342816 A1
(43) Pub. Date: Oct. 26, 2023

(54) Advertisement with a Short Message and Driving Instructions

(71) Applicant: Chian Chiu Li, Fremont, CA (US)

(72) Inventor: Chian Chiu Li, Fremont, CA (US)

(21) Appl. No.: 18/217,769

(22) Filed: Jul. 3, 2023

Related U.S. Application Data
(63) Continuation-in-part of application No. 17/373,705, filed on Jul. 12, 2021.

(51) Int. Cl. G06Q 30/0251; G06Q 50/30; G06Q 30/0601

(52) U.S. Cl. CPC G06Q 30/0265; G06Q 50/30; G06Q 30/0643

(57) ABSTRACT

In an aspect, after a user launches an app at a device, ads of nearby businesses show up. The ads each contain a name of a business and a short message from the business. In another aspect, ads presented in a vehicle contain a name of a business, a short message from the business, a button for placing a purchase order, and a button as a driving command for requesting the vehicle to drive to the business.

### CROSS REFERENCE TO RELATED APPLICATION

This is a continuation-in-part of U.S. patent application Ser. No. 17/373,705, filed Jul. 12, 2021, which is a continuation-in-part of U.S. patent application Ser. No. 15/344,555, filed Nov. 6, 2016. This application is related to U.S. patent application Ser. No. 17/342,504, filed Jun. 8, 2021.

### BACKGROUND

### Field of Invention

This invention relates to advertising, and more specifically, to advertising utilizing a short message, advertising in a vehicle, and advertising with driving instructions.

### Description of Prior Art

A social networking system provides an online service, platform, or website that implements social networks or social networking circles, where users may share news, information, ideas, or feelings. A social networking environment is mostly web-based, and it enables users to interact with each other over the Internet, via online posts, instant or short messages, tweets, or emails. As smartphone systems support a social networking environment and many users have a smartphone, a social network may provide an effective communication platform. For many entities, such as retail stores, online stores, restaurants, service providers, organizations, and agencies, a social network may work as an advertisement platform as well. For instance, a business may design a webpage as a circle interface to present products, promotions, sponsored content like ads, etc.

It is relatively straightforward to convert a circle interface into an advertising platform, as an interface may display information in many ways. But it's not easy for a business to attract users to visit a circle interface and view content items presented there. It is also not easy for users to find wanted promotions, given the fact that there are a lot of ads that target users.

Therefore, there exists a need for a business to present ads effectively and efficiently and a need for a user to find needed ads conveniently.

When an ad is presented to a user inside a vehicle to promote a product, there exists a need to provide options that facilitate the user to purchase the product.

The word “post” as a verb or “posting” is referred broadly as transmitting information from a user to a server via a communication network to let others in a certain environment, such as a social networking circle, access the transmitted information. The word “post” as a noun includes information posted or submitted by a user on the Internet, or user generated content on the Internet or in any network. Posted information or content may cover a hyperlink or a uniform resource locator (URL), audio, video, an image, a text, a message, an e-mail, a news article, a blog entry, a survey, etc. Posts are preferably hosted on a web site, but may also be hosted locally using local database or a local server system. In descriptions below, messages, besides posts, are used sometimes. “Message” as a noun may be considered equivalent to a post in some cases and considered as a statement, a sentence, a notice, or certain information to be conveyed in some other cases.

### Objects and Advantages

Accordingly, several main objects and advantages of the present invention are:
a). to provide an improved advertising method;
b). to provide such a method which presents an ad having a short message;
c). to provide such a method which enables a business to advertise easily, independently, and directly;
d). to provide such a method which enables a business to present ads or change ad content in real time; and
e). to provide such a method which provides options for a user in a vehicle to place a purchase order or submit driving instructions to request the vehicle to drive to a business.

Further objects and advantages will become apparent from a consideration of the drawings and ensuing description.

### SUMMARY

In accordance with the present invention, advertising methods and systems are proposed. An ad may contain a short ad message. A user may view ads from nearby businesses. A business may present and manage an ad easily, directly, and without a middleman. When an ad from a business is provided to a user inside a vehicle, the ad may contain an interactive button for starting a purchase process. The ad may also contain an interactive button for the user to issue a driving command for the vehicle to go to the business.

### DRAWING FIGURES

FIG. 1 is an exemplary block diagram describing a user device embodiment in accordance with the present invention.

FIG. 2 is an exemplary flow diagram showing embodiments of presenting ads and accessing a store circle in accordance with the present invention.

FIGS. 3 and 4 are graphic diagrams depicting embodiments of a circle app interface, where store circles and short ad messages are displayed in map and text modes respectively in accordance with the present invention.

FIGS. 5, 6, and 7 use exemplary flow diagrams to show embodiments of displaying store circles and short ad messages in an app interface and accessing a store circle interface in accordance with the present invention.

FIG. 8 uses graphic diagrams to show accessing a store circle via an interactive map in accordance with the present invention.

FIG. 9 is a graphic diagram illustrating an embodiment of a circle app interface, where each circle icon contains multiple lines of messages in accordance with the present invention.

FIGS. 10-A, 10-B, and 10-C each show a schematic flow diagram which depicts a process to obtain a search result in accordance with the present invention.

FIG. 11 is an exemplary flow diagram which illustrates an embodiment of an assisted process to build a store circle interface in accordance with the present invention.

FIG. 12 shows an exemplary user interface inside a vehicle that provides ads with options for placing a purchase order and requesting the vehicle to go to a business.

FIGS. 13-A and 13-B show an exemplary circle app interface at a user device that provides ads with options to go to a business.

### REFERENCE NUMERALS IN DRAWINGS

| | | | |
|---|---|---|---|
| 10 | Camera | 12 | Device |
| 14 | Processor | 16 | Computer Readable Medium |
| 18 | GPS Sensor | 20 | NFC Sensor |
| 22 | Screen | 24 | Icon |
| 26 | Icon | 28 | Icon |
| 30 | Icon | 32 | Smartphone |
| 34 | Device | 36 | Screen |
| 38 | Icon | 40 | Icon |
| 42 | Icon | 44 | Device |
| 46 | Display | 48 | Icon |
| 50 | Icon | 52 | Button |
| 54 | Button | 56 | Button |
| 58 | Button | 60 | Smartphone |
| 62 | Screen | 64 | Icon |
| 66 | Icon | 68 | Button |
| 70 | Button | 72 | Button |
| 74 | Button | 76 | Button |
| 78 | Button | 80 | Button |

100, 102, 104, 106, 108, 110, 112, 114, 116, 118, 120, 124, 126, 128, 130, 132, 134, 136, 138, 140, 142, 144, 146, 148, 150, 152, 154, 156, 158, 160, 162, 164, 166, 168, 170, 172, 174, 176, 178, 180, 182, 184, 186, 188, and 190 are exemplary steps.

### DETAILED DESCRIPTION

The following exemplary embodiments are provided for complete disclosure of the present invention and to fully inform the scope of the present invention to those skilled in the art, and the present invention is not limited to the schematic embodiments disclosed, but can be implemented in various types.

A social networking environment may involve a networking system and a number of user devices. A networking system may contain one or more servers. User devices and a network system are connected via communication networks. One or more social networks may be implemented by the networking system in the networking environment.

The word “server” means a system or systems which may have similar functions and capacities as one or more servers. Main components of a server may include one or more processors, which control and process data and information by executing software, logic, codes, or stored executable instructions, or carrying out other suitable functions. A server and/or processor, as a computing device, may include any hardware, firmware, software, or a combination thereof. In the most compact form, thanks to the advance of microelectronic technologies, a server may be built on a single processor chip.

A networking system may enable and implement various types of social networks serving a great number of users. It may exemplarily be divided into three blocks, represented by server, database, and router and switch. A server may include one or more servers processing applications, web applications, images, emails, networking, searching tasks, etc. The database may store data associated with users, networks, servers, and various services. Routers and switches may transmit information packets between a user device and a networking system over communication networks and work as a gatekeeper to and from the networks. As social networks may involve a tremendous amount of data, which may be uploaded and aggregated by a networking system continuously, a separate database system may be created. A database system may include a large number of storage devices or modules and specialty servers for data management and maintenance.

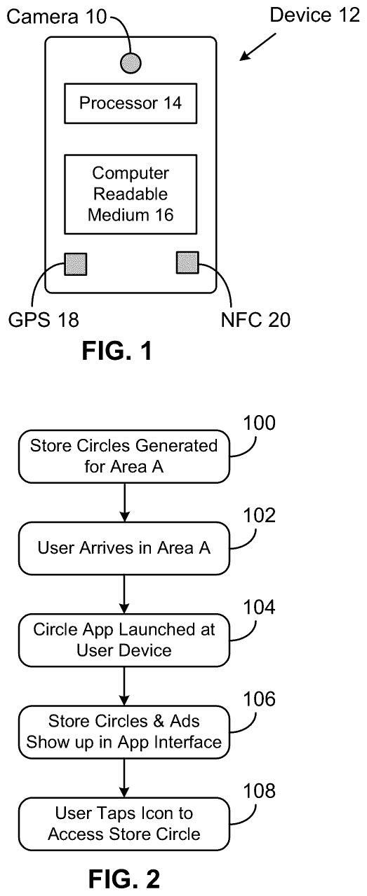

FIG. 1 is an illustrative block diagram of one embodiment according to the present invention. A device 12 may represent a user device or a wireless electronic device, including but not limited to mobile phone, smart phone, smart watch, other wearable device, handheld computer, tablet computer, desktop computer, virtual reality (VR) device, augmented reality (AR) device, and the like. Device 12 may include a processor 14 and computer readable medium 16. Processor 14 may mean one or more processor chips or systems. Medium 16 may include a memory hierarchy built by one or more memory chips or storage modules like RAM, ROM, FLASH, magnetic, optical and/or thermal storage devices. Processor 14 may run programs or sets of executable instructions stored in medium 16 for performing various functions and tasks, e.g., surfing on the Internet, placing phone calls, logging on a website, playing video or music, gaming, electronic payment, social networking, survey, sending and receiving emails, short messages, files, and data, executing other applications, etc. Device 12 may also include input, output, and communication components, which may be individual modules or integrated with processor 14. Communication components may connect the device to a server or another device via a communication network. Usually, Device 12 may have a display (not shown) and a graphical user interface (GUI). A display may have liquid crystal display (LCD) screen, organic light emitting diode (OLED) screen (including active matrix OLED (AMOLED) screen), or LED screen. A screen surface may be sensitive to touches, i.e., sensitive to haptic and/or tactile contact with a user, especially in the case of smart phone, tablet computer, smart watch, and certain wearable devices. A touch screen may be used as a convenient tool for a user to enter input and interact with a system.

Furthermore, device 12 may have a microphone (not shown) and a voice recognition mechanism to receive and interpret a user's verbal command or audio input. In addition, device 12 may have a gesture detection mechanism to receive a user's gesture instructions. For VR and AR devices and some wearable devices, a virtual screen or screen having a very small size may be arranged. While it is inconvenient or impractical to touch such a screen, verbal commands and gesture instructions may become useful for users. In descriptions below, the word “screen” may include a virtual screen and a screen with a very small size, like smaller than a one inch by one inch square or even smaller than a fingertip. A networking app interface or networking circle interface may be displayed on all kinds of screens.

A communication network which device 12 may access may cover a range of types such as the Internet or the World Wide Web, a local area network (LAN), a wide area network (WAN), a metropolitan area network (MAN), a telephone network, an intranet, wireless, and other types of networks. Device 12 may be connected to a network by various wired, wireless, optical, infrared, ultrasonic or other communication means. Via communication networks, device 12 may communicate with a remote server of a networking system or service center to send and receive data or messages.

Device 12 may include a camera sensor 10. Sensor 10 may be a regular phone camera module used by a user to take pictures in daily life. The camera sensor may be arranged to scan a quick response (QR) code, one-dimensional barcode, or any other machine-readable code with the help of certain application. A QR code or barcode may be printed out and displayed for public use easily.

Device 12 may include a global positioning system (GPS) 18. GPS 18 may enable a device to get its own location data. Besides the GPS method, device location info may also be obtained using wireless triangulation methods, or other suitable technology, which may be prepared by a service provider or on-site service facility. Usually for indoor or some urban environment, positioning methods other than GPS are used, since GPS requires a clear view of the sky or clear line of sight for four GPS satellites.

Furthermore, device 12 may have near-field communication (NFC) capability enabled by an NFC sensor 20. NFC is of short-range wireless communication technology and may be employed to communicate securely between NFC devices. Sensor 20 may also be used to read a radio-frequency identification (RFID) tag. RFID is also a wireless technology for the purpose of data transfer, such as transfer of identification data, passively or actively. A RFID chip or RFID tag may be made very small in size, e.g., smaller or much smaller than one millimeter. It may be manufactured by semiconductor technologies. In application, a RFID tag may be conveniently placed, for instance, on a table or wall for public use.

Inside device 12, output signals of sensors may be transmitted to processor 14, which, employed with certain algorithms, may process the data and act according to predefined programs. For instance, processor 14 may process data from NFC sensor 20, transmit certain messages to a networking system or service center, and then wait for instructions or new messages from the system or center.

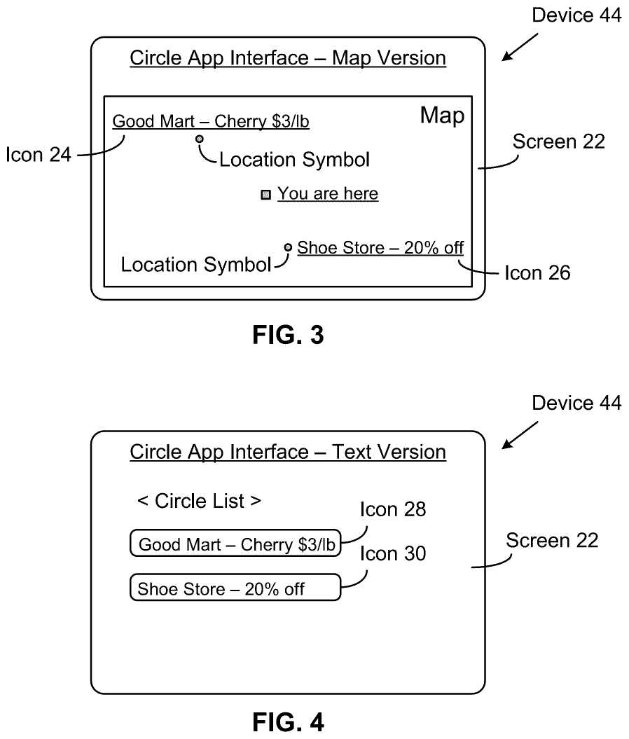

FIG. 2 is a schematic flow diagram showing advertising via a circle app interface and access of a store circle. Assume that certain businesses such as retail stores located in Area A want to have their own social networking circles and use the circles to do advertisement. The stores may submit application and needed info at service center. Service center may approve store applications and generate respective store networking circles or store circles at Step 100. Store circles are open to all users without the need of invitation, recommendation, verification, and/or registration. After a user arrives in Area A at Step 102, the user may start a networking circle app at a user device at Step 104. Then communication between service center and the user device may be established. Service center may obtain the user's location that is Area A and send related circle and ad info to the user device. Next on a display screen of the user device, a circle app interface may show store circles of stores which are close by and the stores' ads at Step 106. Names of the store circle and the store's advertisements may be presented using icons in the circle app interface. Finally at Step 108, the user may select a store circle and tap its icon to access it, assuming that the display screen is touch sensitive. Then a screen view of a store circle interface may appear showing the store's products and promotions.

As illustrated above, the circle app interface and circle interface may be employed to present advertisement and product information, respectively. The circle app interface is an interface after a circle app is launched. The circle interface is an interface after a user logs in a networking circle. In descriptions below, the word “store” is used in many cases. The word “store” may be used as an example of a business, an organization, or a government agency. It is noted that the word “business” alone covers a wide range of fields, such as a retail store, an online store, a restaurant, a service provider, a travel agency, etc. Advertising methods illustrated in one case may apply to other cases.

After a user starts a circle app at a user device, like a smartphone, an app interface may show up with names and logos of nearby store circles. Since there may be quite a few stores in a region, a screen may become too crowded if each store presents a sizable piece of advertisement. Thus it may be designed that a store or entity may only display limited advertising content occupying a predetermined area in a circle app interface. For instance, a store may only be allowed to display a short ad message within a defined screen area.

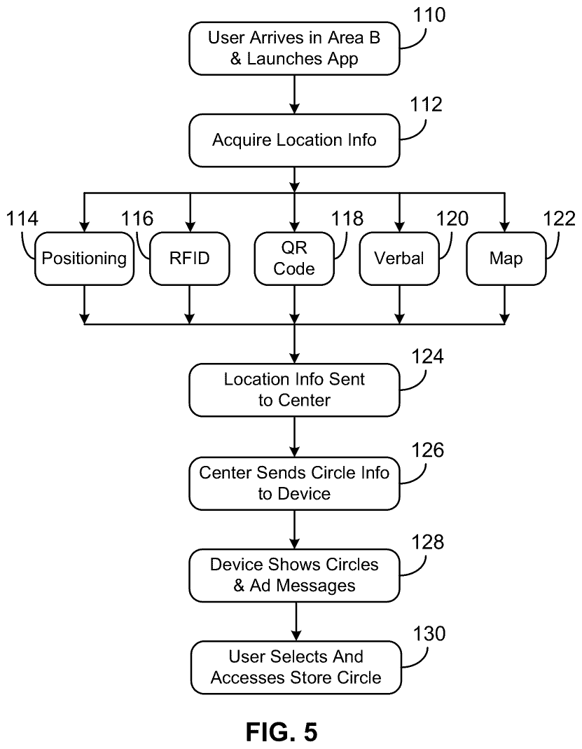

A short ad message may be combined with a circle name and the two may be presented together to show a store has a special on a product. For instance, a grocery store named “Good Mart” may have a store circle with the same name. Assume that circle “Good Mart” shows up in a circle app interface on a screen of a user device. In order to help a store present advertisement, it may be designed that a store may add a brief promotional message to its name in a circle app interface. The short ad message may be anything that is clear and short. For instance, circle name plus a short ad message may look like “Good Mart—Cherry $3/lb”, which is shown schematically on an icon 24 in FIG. 3. FIG. 3 depicts a circle app interface in a map mode graphically. In the figure, a user device 44 shows a map with a title “Circle App Interface—Map Version” on a screen 22. The figure also shows another circle with an icon 26 “Shoe Store—20% off”. It is seen that each exemplary store circle has a small location symbol and an interactive name-plus-message icon. The location symbol indicates a store's geographic location. A user's own location is displayed on the map as well. The store location data may be submitted by a store when a circle application is filed.

For some businesses, a logo may be added to form a logo-plus-message icon or logo-plus-name-plus-message icon, making a store icon catchy on screen. After viewing store icons in a circle app interface, a user may tap or click on one of them. Next, an interface of a corresponding store circle may show up and the user may access the content of the store circle.

FIG. 4 shows a circle app interface in a text mode. Shown in an app interface are a title “Circle App Interface—Text Version” and a circle list containing icons 28 and 30. Icons 28 and 30 represent the same store circles as icons 24 and 26 with the same content items. When a user is familiar with stores nearby and there are many stores, text mode may work better than map mode, as icons may be placed orderly on screen. Basically, FIGS. 3 and 4 show the same result in different presentation ways. Buttons may be arranged in the interface for switching between map and text modes. For instance, buttons “Text Mode” and “Map Mode” (not shown) may be arranged in the two figures respectively. The former button invokes the text version of the app interface, while the latter switches it back to the map version.

A short ad message displayed in an icon, such as “Cherry $3/lb”, may have a length limit or element quantity limit in presentation of single line style. The length limit may mean the appearance of a short ad message on screen is limited by the lateral dimension or width of an icon, while the icon width may be a value arranged by service center. Since an icon also contains a circle name, the length of a message is smaller than the icon width. In addition, the maximum element number of a short ad message may be set, for example, at thirty, where the elements may include a letter, a character, a single-digit number, a sign, an image, etc. An ad message is arranged short and brief such that the app interface may look neat and a user may catch a circle name and ad message easily and quickly. Furthermore, a short message is easier to comprehend than a long one. When a store circle gets a user's attention, the user may tap its icon on screen to log in its circle interface, where more information is prepared. As illustrated above, content items shown in a circle app interface and circle interface are open to all users. In a circle interface of a store, the store may display an announcement, promotional info, product info, contact info, and a feedback window where eligible users may post comments, messages, images, video clips, etc. A store may build a circle interface to present products using images, texts, video clips, and links to web pages of the store and products. The web pages may be designed and managed separately and used as a source of information for the store circle interface.

For a store clerk who manages a store's circle interface, a small ad space or ad window with a title “Submit Ad Message” may be configured in the circle interface where anything entered is considered as a promotional message or short ad message. The message may be taken by service center and displayed with the circle name in a circle app interface. The small ad window makes doing advertisement simple, convenient, and at will. As the store clerk knows, once a short sentence is keyed in and a “Submit” button next to it is tapped, a short ad message is created and it may appear in the app interface in real time. Meanwhile, the short sentence may stay in the ad window for display, reminding the store clerk of the content of the current ad message. The ad window may be used to adjust an ad message in real time as well, since content entered in the small ad window of the circle interface may be transferred to an icon in the circle app interface instantly. From a technical point of view, after a store clerk taps “Submit” button beside the ad window, the content in the window is transmitted to service center. Then, service center sends the content to a user who is close to the store and whose device is showing a circle app interface. Thus, the circle app interface may be refreshed in time and promotional messages may be updated almost instantly. Hence, a store clerk or store circle may post or change the ad content directly, conveniently, independently, and in real time. The word “directly” may mean a store may publish an ad message in the circle app interface without a middle step, like a review or approval by any party, and in real time. The word “independent” may mean a store may post and edit an ad message in the circle app interface, i.e., a public domain, by itself, as no outside assistance or approval is needed. “In real time” may mean in a very short period of time, such as within milliseconds or virtually immediately.

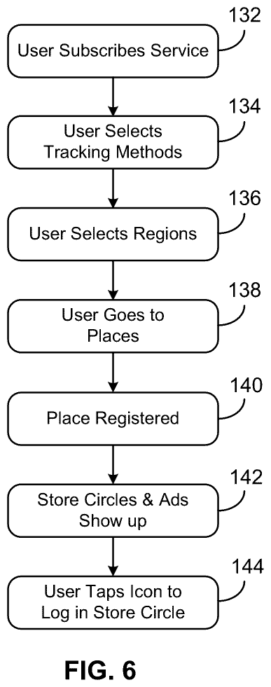

FIG. 5 shows a schematic flow diagram of accessing a store circle and describes various positioning mechanisms. Assume that a user arrives in Area B and launches a circle app at a user device at Step 110. Next, the user device, a service carrier, or an on-site facility starts to collect location data at Step 112. Depending on the program setting, a user may register a place via different methods, since there are several technologies available for location detection. “Register” as a verb may mean a user causes submission of location records to service center actively or passively to provide an evidence of being present at a place.

At Step 114, a positioning technique such as GPS or a triangulation method is used to get the user location automatically and directly. The GPS method requires a GPS sensor, such as sensor 18 of FIG. 1, while the triangulation method may be conducted by an on-site facility or wireless service carrier.

At Step 116, the RFID technology is used. An RFID tag may be displayed for public use at a place. If a user device has an NFC sensor, like sensor 20 of FIG. 1, a user may swing the device in front of an RFID tag to read it. An RFID tag may contain location info and link data so that it may assist a user device to log in a store circle directly. Alternatively, an RFID may be designed as a location indicator, that is, the tag only provides location data to a user device. The user device then sends the data, as instructed by the circle app, to service center to let the center know where a user is.

Step 118 introduces a QR code method, which works in a way similar to the RFID method. The code may contain login instructions for accessing a circle or just info of a location. As a location indicator, an RFID tag and QR code may provide precise geographic information. They are especially useful when other positioning method is not available, not preferred due to privacy concerns, or not precise enough. But the RFID and QR-code methods are not automatic and they require a user to take action, either swiping a device in front of a tag or aiming at and scanning a QR code.

A user's location may also be determined by the user himself or herself via a verbal method as at Step 120. With the voice recognition technology, a user may utter a name of a place or venue to a device. The verbal method is not only useful, but also convenient, as saying a word or a few words is all it takes.

Step 122 employs the map method. The method is convenient for on-site users when the user location is not precise. For instance, when the user location can't be determined accurately enough and there is no RFID tag or QR code printout in sight, a user may open a circle app and select map mode. Next, an interactive map may appear on screen. The user may search the map and find a spot of interest. The user then double taps the spot, which may be designed as a confirmation act to specify a location of the user.

With a circle app in operation, a user's location data is sent to service center at Step 124, after the location data is acquired. The center then finds out which store circle or circles should be presented to the user based on location info and predetermined arrangements. It may be designed that a location-based store circle has a defined geographic coverage or designated geographic circle area. Shape and range of designated circle area may be defined by service centre or proposed by a store which a circle is assigned to. When a circle area is submitted by the store, service center may evaluate it and approve it with or without any change. If a user's location is in a circle's designated area, the circle may be selected and presented to the user. Since store circles' designated areas may overlap, a user may be located at a place claimed by multiple circles. In such a case, multiple circles may be presented to the user who may review these circles and select one to log in for more information.

Alternatively, a designated geographic user area or designated user area may be defined. All store circles whose location is in a designated user area may be considered relevant to a user and may be chosen and presented to the user. A designated user area may have any shape and dimension specified by service center or a user. For instance, a designated user area may have a circular shape whose center is of the user location. A circular area's radius may be defined by service center as a default setting which may be adjusted by a user later on. Examples of radius value may include one mile to ten miles. If the radius is of one mile, store circles whose location is within the one-mile range may be selected and provided to user. It is noted that store circles may be presented in the map or text mode at a user device. In the map mode, a map may show up which covers a designated user area. The map may have a square, rectangular, or another shape. In the text mode, interactive store icons may form a list or appear on a list as shown in FIG. 4. It is noted that interactive icons of store circles may show up with or without a short message, since some stores may not do it sometimes.

After retrieving info of store circles, service center may send it to a user device for presentation purpose at Step 126. Then at Step 128, the user device may display icons of store circles, i.e., circle names and short ad messages may be presented in the app interface. A user may glance at the app interface and ponder which nearby store looks interesting. Next, the user may tap an icon to log in a store circle at Step 130. If a user is busy, the user may access a circle at a later time. As the circle info is received at the user device, it may be stored for a given period of time, say a week. An interactive “History” button may be configured in the circle app interface. Once a user taps “History” button, circles encountered and recorded within a defined time frame may appear on screen. A user may tap a circle icon to enter a circle.

FIG. 6 shows an exemplary flow diagram of displaying ads and accessing a store circle from another angle. In order to participate in activities of location-based store circles, a user may start by opening an account or subscribing the networking service at service center at Step 132. The procedure may be required for users who like to have location-based promotional information conveniently. It may also be required if a user wants to publish a post in a store circle. If a user is not registered, he or she may still get the same location-based info, with more steps though. For instance, a user may log on a website of service center, find a place on a map, and view store circles and ad messages after zoom-in. With the same method, all online users may visit the service center website, find a store circle on a map, and tap on it to access the content of the circle. Thus store circles illustrated here are configured open to all users. However, only registered user may be allowed to post content on store circle sites. In addition, whether or not to allow users to post in a store circle may be determined by each store. Some stores may not permit posting by users due to administrative issues.

When a user is interested in the location-based networking service, the user may download a circle app from the service center website and install it at a user device. Service center may create or arrange the app and upgrade it regularly. During app installation, a user may be asked to submit info such as name, email address, place of residence, and preferred user name. As a result, service center may know a user's identity and other personal info, and thus may be able to help the user log in store circles and certain other social networks without another round of registration process and without password entry. Consequently, a user may carry a user name registered at service center and use it in various participating circles. The arrangement makes certain social circles free of registration and in the meantime, a user doesn't need to create a user name for every circle encountered. When a user doesn't want to use a registered user name in a circle, the user may choose an option to get a temporary user name assigned for use in that circle.

At Step 134, a user selects options of tracking schemes. As location data is a critical part of the circle program, a user may decide which detection method would be employed. Location data contains sensitive personal information, so some users may be concerned about privacy leaks. For instance, some may not want service center to know all places he or she has been to. As a result, automatic positioning method like GPS and triangulation may be turned off by some users, while some manual methods such as the RFID, QR code, verbal, or map scheme may be selected, which means location records are collected and reported only after a user initiates it. In practice, a user may place a user device close to an RFID tag to read it, arrange a phone camera to aim at a QR code to scan it, utter to a user device, or tap a spot on a map.

Next the user device may transmit location info to service center. When the GPS method is selected and a GPS device is turned on, the circle app may acquire location info and send the location data to service center automatically, assuming the circle app is started already. After receiving location data, service center may use it to retrieve names of relevant store circles along with promotional messages from some circles. It is noted that not every store circle carries a promotional message. So, a circle app interface may display store icons with or without a short ad message. After the retrieval process, circle info may be transferred to the user device subsequently. If the triangulation or other positioning technology such as the ultrasonic method is selected, the user's location data may be collected and sent to service center automatically from a contracted service, still assuming a circle app is on. When a circle app is off and a user arrives at a place, a user device may not communicate with service center and submit or help submit location records. But a user may authorize a service provider or service facility to collect his or her location records and transfer the records to service center. Thus whether a circle app is on or off, places may be registered and circle info may be stored for future use automatically.

At Step 136, a user selects regions of interest. As a user may pass many places on a routine basis, a lot of store circles may be registered regularly. A user may like some circles, but pay less attention to some other circles. So there is a need to avoid registering certain places and limit the quantity of circles in daily life. A user may single out some places or regions and stay away from circles associated with those locations. After a user delists a place to avoid it, corresponding store circles may not appear even the place is registered by a user.

As a user goes out at Step 138, commuting to work or doing things after work, he or she may register places automatically or manually. Assume that the user turns on the circle app and registers a place at Step 140. Then icons of store circles may show up in the app interface on a device screen at Step 142. As described above, a circle icon may contain a circle name or a circle name plus a logo. When a store has promotions, a circle icon may display a short ad message. Store circles presented in the app interface are selected by service center based on location info of the user and circles. After a while, if the user goes to another place, circle icons may be replaced automatically by another batch corresponding to the new location. At Step 144, the user may tap a circle icon, which prompts the user device to send a message to service center. Service center may start retrieving info of a corresponding circle and pass it to the user device. Next, a circle interface may appear at the user device and the content of the circle becomes accessible.

FIG. 7 shows a schematic flow diagram of store circle formation and administration. Assume service center is in charge of store circle creation and management. When a store wants to have a location-based store circle, the store may log on a service center website and file an application. Info required for application may include store name, address, contact info, person responsible for the store circle, business license number if available, proposed circle name, and so on. Service center may review the application data and approve a store circle and its name. As a circle name appears in a circle app interface, it should be short, have an element quantity limit, and resemble the store name. Then service center may assign a circle to the store along with an account number and a temporary password. Service center may approve multiple applications from a region and assign circles to respective businesses or stores, as at Step 146.

When the circle application process is completed, both the store and service center may make the news public. A store may display signs in the store to encourage customers to visit the circle online. As store circles may be managed by service center, the center may monitor activities of store circles at Step 148. For instance, when a store changes certain circle content, service center may make an update at the center's database.

At Step 150, service center receives a request for circle info from an on-site user, which may happen after the user launches a circle app. Start of the circle app may mean a user is looking for store circles and promotions nearby. The user request and location info may be transmitted to service center automatically by instructions from the circle app. Next, service center performs a search based on data received to get info of relevant circles and short ad messages. Then at Step 152, service center sends circle and ad info to the user device, which may be presented in a circle app interface for the user to review. The user may take a look at the interface and tap a circle icon to select it. Next at Step 154, service center receives the selection info from the user. At Step 156, service center retrieves data of the selected circle from database. Circle data is then transmitted to the user device for presentation at Step 158. Finally at Step 160, the user device, as directed by the circle app, displays a circle interface based on data received from service center.

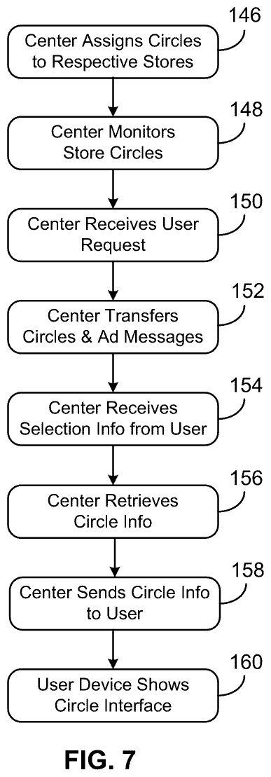

FIG. 8 uses graphic diagrams to show steps to access a store circle. Take a smartphone 32 as a user device. Assume the phone shows some apps in an interface. A user may tap icon “Circle App” to launch the program at Step 1. Then the app gets started and sends a message to service center. The message may contain location data of phone 32 and a request for circle info nearby. After receiving circle info from service center, phone 32 shows a circle app interface at Step 2. There are two store circles showing up on a map, one with a short ad message “7% off”. The circle location and user location are also displayed. Next at Step 3, the user selects a store circle “Bon” and taps its icon on screen. The phone receives the input and sends the info to service center via an algorithm of the circle app. Service center then retrieves info of circle “Bon” from database and transmits it to the phone. Next, phone 32 obtains new info and uses it to present a circle interface of “Bon” at Step 4. The user may view products, promotions, and comments from other people from the interface. Thus, it is seen that accessing a store circle is simple, easy, and convenient for onsite user. No registration. No password. A user may start a circle app, view info from stores close by, and then choose a store to find more detail.

When a user's location is known, a circle app may show a map covering the location in an app interface. A corresponding map area may be specified by service center, the circle app setup, or a user selection. The map area may be of a designated user area which is described above or may overlap a designated user area with a certain degree. For instance, if a designated user area is circular, a map may show the exact circular area or a square which covers most of the circular area.

A map area in a starting circle app interface may also be an area which is large enough to include locations of local circles, where a local circle may mean a store circle whose designated circle area covers a user's location. The setup of a map area in a starting interface may be edited by a user. For instance, a user may change the shape of a map area from square to rectangular. After a map area is determined, service center may retrieve all circles whose location is in the area and send circle information to the user for presentation. On the user device side, info from service center may be received and then displayed in an interface as instructed by the circle app. For instance, a map dotted with circle icons may be presented on a screen.

A user may access nearby social circles conveniently after arriving at and registering a place. Such a user may be called “local user” for those store circles. But a store circle may also be accessed by users who are not there, whether registered or unregistered. These users may be called “remote user”. A remote user may be close to the place or thousands of miles away from it.

More specifically, it may be defined that a user is considered a local user for a store circle if the user is physically located in the circle's range or designated circle area. When a user is located out of the designated circle area, the user may be considered as a remote user to the store circle.

For a store, it may be important to know the quantity of checked-in local users, which may reflect a potential customer base. “Checked-in users” may mean users who have submitted location data, the same as users who have registered the place. Thus it may be designed that the quantity of checked-in local users may be presented to the store circle. For instance, when a store clerk logs in the store's own circle interface, which is different from the one shown to the public, the checked-in local user quantity may be displayed in the interface. Thus, a store may conveniently monitor the number of checked-in local users before making a promotional decision. For instance, a store may have promotions valid for local users only, e.g., only local users may collect electronic coupons of limited quantity.

Since some store circles have no promotional message to present, their circle icons may show a circle name or a name plus logo only in the circle app interface. On the other hand, some users may like to see promotions and some may not. To accommodate different needs, two interactive buttons, “Ads” and “No Ads”, may be arranged in the circle app interface. For instance, when the “Ads” button is activated, an interface may only show circles which have an ad message. Accordingly, all circle icons shown on screen may have a circle name and a short ad message. As some circle icons which don't have short ad message are removed, new circle icons may be retrieved and presented which replace those without an ad message. Some of the new circles may not be local circles but are still relatively close, which may not be considered as an issue since sales info may become more important to users when “Ads” option is chosen.

When the “No Ads” button is activated, short ad messages in app interface may be removed such that only circle names or names and logos are displayed. It is noted that the circle distribution or lineup is not altered in such a case, while the only change is that some circle icons have less content. After a user taps a button to show or not to show the ad info, the circle app or service center may implement it. For instance, the circle app may be designed to have a function which may present a circle icon with or without a short ad message. If it is handled by service center, service center may act after receiving the selection info from a user. Service center may send data and instructions to a user device and cause the app interface to show a list of circle icons with features selected. It is noted that an app interface may be in the map mode or text mode. Methods described above apply to both scenarios.

Moreover, two kinds of icon widths may be designed, a narrow one for a name or a name plus a logo only, and a wider one for a name (or a name and a logo) plus a short ad message. Thus, two types of icons may appear in the circle app interface. As a result, when “No Ads” button is tapped, all icons become the narrow ones, which may make the app interface look neater.

A short ad message which appears in a circle app interface may play an important role in store management. The ad message may be created and edited by a store clerk directly and in real time. The store clerk may mean a user who is authorized to manage a defined part of content of a store circle interface and administer certain activities of the store circle. For instance, a store clerk, with permission of the store owner, may request service center to create a store circle and assign her or him as an administrator of the circle. Then the clerk may generate and edit a short ad message which shows up in the app interface. As already shown, a circle icon may contain two parts, a circle name, with or without a store logo, and a short ad message. The circle name may be fixed and may only be changed with the approval from service center. But a short message may be changed independently anytime by a store clerk, with a service subscribed in some cases. Thus, a store may be able to present ad info in the app interface anytime. As illustrated, a short ad message may be anything within a length limit or element number limit. Examples of short ad messages may include “Holiday Sales”, “$3 Cheese Burger”, “Next Show @7:00 pm”, etc. Since certain promotional info may be changed or updated by stores frequently, the circle app interface may become a dynamic advertising platform. In a similar way, the circle interface may work as a dynamic advertising platform too, since a store may use its circle interface to present different products and services at different times. For instance, a store clerk may check sales status and adjust a short ad message in the app interface and other promotions in the circle interface in time and on demand.

When a user taps a circle icon in an app interface, the circle's interface may appear. As described, a circle interface may contain a feedback window where users including the local users, remote users, and store clerks may chat and post comments and messages. A store may use the circle interface to display various content items, such as text messages, tables, forms, graphic presentations, and interactive icons representing links to specific web pages or websites. All of these content items may be prepared for introducing products and services, presenting promotions, and displaying advertisements. It may be designed that a store may edit or change self-created content items freely. For instance, promotional info in a circle interface may be changed by a store based on actual needs and displayed at a consumer's device in real time. The reason is that once a content item in the circle interface is changed, the info is transmitted to service center automatically by the circle app algorithm. Then service center may store the info at product database and pass it to user devices which request such info. The circle interface may also be arranged to display content items coming from service center. For instance, a store circle interface may display ads made by a manufacturer of a product which is unrelated to the store. A store may be compensated for other's ads shown in its circle interface.

In a circle app interface, a circle icon may only be allowed to have a small footprint to show one line with limited content, such as “Pizza House: Medium Half Price”. Because sometimes a store may have a need to present more advertising content items, an arrow button may be added and placed next to a circle icon. For instance, a small arrow button may be attached to the right side of a circle icon. When the arrow button is tapped, a pop-up window may show up displaying more content items in multiple lines temporarily, where each line may contain an interactive secondary icon showing a different short ad message. A user may tap a secondary icon to select a product of interest. After a secondary icon is tapped, the window closes and the circle icon presents the selected message in the app interface. For instance, a circle icon may show a short ad message “All Toys 25% off” at the beginning. After a secondary icon “Flexible TV $100 Rebate” is tapped, the short message of the circle icon is switched to the television rebate. After that, the user may check and change content of other circle icons. Then modified ad messages may show up in the app interface. The user may compare sales info on similar products easily and conveniently.

When a user taps an arrow button beside a circle icon, multiple lines may pop up for the user to view and select. But too many lines may make a user feel stressed or confused. Thus there may be a limit for the number of lines in a pop-up window along with the length limit or element number limit for each line. The limits may be defined by service center. For instance, the maximum line number may be set between five and ten. Moreover, a “Multi-Line” button may be arranged in the circle app interface. Once the “Multi-Line” button is activated, each circle which is presented in the circle app interface may display more lines. When a store circle has a chance to display more lines in the circle app interface, more sales items or info may be presented. A store clerk may prepare multiple lines for use in the app interface after entering “Edit” mode in the circle interface. In some cases, another interactive button such as “Single Line” may be arranged for switching from the multi-line mode to the single-line mode in the circle app interface.

As a default setting, after a circle app is launched, an app interface may show a list of local circles and possibly some other circles whose locations are relatively close by. Some circle icons may contain a short ad message, while others may show a circle name only. Sometimes, a user may look for sales of a product and is less concerned about the store location. Thus there exists a need to present store circles based on promotional info, product info, or other info chosen by a user.

For instance, service center may collect short ad messages which are prepared by stores for display in the app interface. Such data is easy to get, since the content of the short ad messages is transferred to service center after being submitted by stores. Service center may receive and collect ad messages from store circles and keep the info at product database. In the app interface, a small space may be arranged with a tile “Ad Word”. After a user enters a query word or query words in the space and taps a “Search” button, the query word or words may be transmitted to service center. Service center may start a search based on the query at product database. The center may retrieve relevant circles whose short ad messages are relevant to the query. Optionally, service center may search among current active short ad messages only. That is, only circles that have an active short ad message are searched. The search is performed by detecting whether a short ad message of a store is relevant to the query. If it is relevant, the store having it is selected. Next a list may be sent to the user and the list may show up in the circle app interface. On the list, each line may display a circle name plus a short ad message. As described, the messages each contain information relevant to the query. Thus, a user may look at the list, recognize familiar stores, and compare discount info conveniently. In some cases, when service center does a search, it only selects stores whose location is within a certain range of a user, say ten to fifty miles. The search range may be adjusted by a user and a new search may take place after a new range value is entered.

Furthermore, online stores may be included in a search process too. Online store is a store which doesn't have a retail space for people to visit physically, look at real products, and shop there. In descriptions herein, the word “store” as a noun may mean a physical store or retail store. When an online store wants to be included in a search, it may register at service center and get approval for serving a certain region or multiple regions. Online stores may carry a special mark to differ from physical stores when showing up in the app interface, so users may know right away whether it is an online store or retail store.

Since some users may prefer shopping at physical stores and some prefer online stores, there exists a need to provide different options in a search process. For instance, small check boxes “Retail Store Only”, “Online Store Only”, “Retail & Online Stores” may be arranged in a circle app interface. The boxes cause display of different search results in the circle app interface, respectively. When the “Retail Store Only” box is checked, for instance, search results may only contain circle icons of retail stores. When the “Online Store Only” box is selected, search results may only show circle icons of online stores. When the “Retail & Online Stores” box is selected, search results may cover circle icons of both retail and online stores.

For users who frequent certain stores regularly, there exists a need to group the stores together for checking promotional info from them conveniently. It may be designed that a user may tap the “Edit” button to enter “Edit” mode in the app interface, tap a “History” button to display a list of store circles visited in the past within a certain time, and then select some store circles to form a group. The user may assign a name to the group. Group info is sent to service center and recorded as part of the user data at user database. In the app interface, a “Group” button may be configured. After “Group” button is tapped, a list of group names may show up. A user may tap a group name. Next group selection info is transmitted to service center. Service center gets circle names from user database. Then info of circles in the group is retrieved from product database and sent to the user device. After receiving the circle info from service center, the user device displays a list of circle icons in the app interface. As illustrated above, each circle icon may contain a circle name and a short ad message. The user may glance at the list of familiar store circle names, check short ad messages, and make a decision to go to a store or tap a circle icon to learn more info.

Before going to stores to make purchases, some users may like to have more info on products such as the brand, quality, and origin place or place of manufacturing. Thus, there exists a need for users to obtain such info easily and a need for stores to provide it conveniently. For instance, after a store clerk taps “Edit” button to enter an “Edit” mode in the circle interface, the clerk may go to “Data Entry” section to key in product information including the model number, version number, brand, manufacturing or producing place or country, quality status, pricing info for selected items, etc. The data entry format may be designed by service center. For instance, a data form or table may be prepared to show up on screen for a store clerk to fill in and upload files. Content items of the data form or table may be transmitted automatically to service center and kept at product database after the store clerk taps a “Done” button to conclude an editing process. The data form or table which contains product info may be displayed in the store circle interface for public use. So a consumer may access the store circle interface to view product info in certain depth. Due to limited screen space, only part of the product info may be displayed, while the rest may be reached by scrolling down, turning page, tapping a link, or other actions.

To make it simple for store clerks, a circle app of a specific version may be designed for stores and the circle app may retrieve data from a designated file or website of a store. For instance, after a store clerk enters “Data Entry” section, a “Data Retrieval” button may be arranged in the circle interface. Certain algorithm of the circle app may be designed such that after the “Data Retrieval” button is tapped, the circle app may search a pre-selected file or website for product info and other info and fetch related data automatically. For instance, a small space with a title “Designated File/Website” may be arranged in the circle interface, where a store clerk may select one or more files in a store computer system or enter one or more website addresses. Then the address info of selected data source may be recorded by the circle app and used when needed or instructed to do so.

The circle app may import data from selected sources when constructing a data form or table in a circle interface. A data form or table may be configured in a screen area or a window that may be referred to as a product showcase. In some cases, a product showcase may indicate a designated area in a circle interface for a store to present products and services. The product showcase may contain forms, tables, texts, images, video clips, and links to webpages. While a store clerk may create content for a showcase manually, it is more convenient if existing files and webpages may be utilized. A store may use its website to build a product showcase in a circle interface. For instance, a store clerk may choose a circle app function such that certain content items from a website are transferred to a circle interface. Optionally, a showcase window may be created in a circle interface. Content items presented in the showcase window may be fetched from the store's webpages. The method makes good use of a store's existing resources and may provide detailed info for users.

A store clerk may also import data selectively when building a product showcase, since some stores may only want to publically display part of the product info in a circle interface. For instance, a store clerk may select a file and then open it via a circle app. After a file is open, the store clerk may select certain part of it and import the selected part only. A pre-selected file may be an inventory control document or inventory record file at a store. As a store may make changes from time to time, it may be designed such that the circle app may check the content of the pre-selected file or website periodically, say in half-hour, one-hour, or two-hour time interval, or at certain time slots chosen by the store clerk. If any change of the pre-selected file or website is found, the circle app may make changes in the product showcase accordingly and automatically and then the info is sent to service center. Alternatively, the store clerk may change certain content items manually. Again, after a change is made, related info is sent to service center. Thus product info and other content presented in a circle interface may maintain updated either automatically or manually. As any change of content in a circle interface is transmitted to service center instantly, service center may be able to keep and provide updated info to users continuously.

Meanwhile, a store circle interface may have its own advertising area. For instance, a check box may be prepared for each item in the product showcase which indicates whether the item is selected for the advertising area in a store circle interface. A store clerk may check a box and then a corresponding item may appear in the store advertising area automatically. In the store advertising area, the store clerk may enter for each item a short promotional message, like “20% off”, “New Arrival”, “½ Price after 5 pm”, etc. The advertising area is arranged open to the public. Thus a consumer may have an overall view of promotions at a store easily. As other data entered in a store circle interface, all content items in the store's advertising area are sent to service center automatically after they are submitted. Service center may store the info at product database. Such info may become useful when a user searches for advertisement info.

As described above, for the management of the short ad message in an app interface, a small ad window may be arranged in a circle interface, which may have a title such as “Submit Ad Message”. Content entered and displayed in the small ad window is the one which shows up with a circle name in an app interface. Thus a store clerk has a clear view of what appears in the app interface. A “Submit” button may be arranged beside the small ad window. Once the button is tapped, content in the window is transmitted to service center, which then sends the updated info to relevant users. When multiple messages are allowed in an app interface, a store clerk may determine the order of the short ad messages, such as which item is placed at the first place, which is at the second place, and so on. The message at the first place is chosen for display in an app interface in the single-line mode or chosen for display in the first line in the multi-line mode.

One aspect of the product info is quality. Quality status may be represented by, for instance, number of stars, like one to five stars with the five stars standing for the highest quality. Quality status may be determined by a vendor, manufacturer, producer, or store clerk. Another aspect of the product info is pricing and promotion, such as the regular price, discounted price, and special offer. After a store clerk submits product info in “Edit” mode, the data may be transmitted to service center automatically and aggregated in product database.

Service center may collect the product info, short ad messages, and other info from a store circle interface, and keep the data at product database. The data may be used in a search process. A search may be categorized by brand search, origin search, and quality screening besides promotional info search. For instance, a “Product” check box may be arranged in a circle app interface. A user may check the “Product” box and enter a product name and brand name in an entry space next to a “Search” button and then tap the button. After a user device detects activation of the “Search” button, it sends search query items and a search request to service center. When service center receives the inquiry info, a search may be launched at product database. Service center may search a group of store circles which are within a certain range of the user or within a range specified by the user. Next, info of selected store circles is sent to the user. A list of circles may be arranged to appear in an app interface of the user device, where each item on the list may contain a circle name, a product name, and a brand name. The user may tap a circle name to log in a circle interface to get more info.

In addition, “Origin” and “Quality” check boxes may be configured in an app interface. A user may check “Origin” box and enter a query containing a product name and a place name or country name to get a list of store circles which carry products from certain place or country. A user may also check “Quality” box and enter a query containing a product name and star rating to get a list of store circles which have certain products with specified quality or higher quality. For instance, a user may check the “Quality” box, key in “cherry” and “3”, and then tap the “Search” button. The info is sent to service center which may search product database and retrieve store circles which carry three-star, four-star, and five-star cherries. Info of selected circles is then transmitted to the user and displayed in a circle app interface. In the app interface, each item may show a circle name, a cherry brand or the word cherry, and a number for the star rating.

Service center may get notified and receive info automatically once a store clerk submits or changes product info or other content items in a store circle interface. The auto data transmission may be carried out by a circle app which is designed for store use and installed at a store device, such as a smartphone or tablet computer. Service center then adds the info to product database. Such info transfer and sharing mechanism enables service center to update content items at product database and provide users with the newest data in real time. In addition, it may also enable service center to provide users with updated information continuously.

When doing a search, a user may specify a geographic region which may be small or large, close by or far away, domestic or in a foreign country. If a user does not choose a region, a default setting may be a circular area with a radius of, for instance, one to twenty miles. A small input space with a title “Range” may be configured in an app interface. A number as radius and/or a place name may be entered in the space before a search, which may be taken when the query data is collected. A place submitted may be a geographic center of a search. It may also be designed that the geographic range used in a search is automatically adjusted based on the quantity of search results. When there are plenty of search results within a default range, say more than ten items, a search may be conducted in a default range only. But when there are fewer results than a given number within a default range, search range may be expanded automatically until a given number of results are obtained. For instance, assume that a default range only covers five miles. Then the range may go beyond that automatically when the quantity of search results is below a given value.

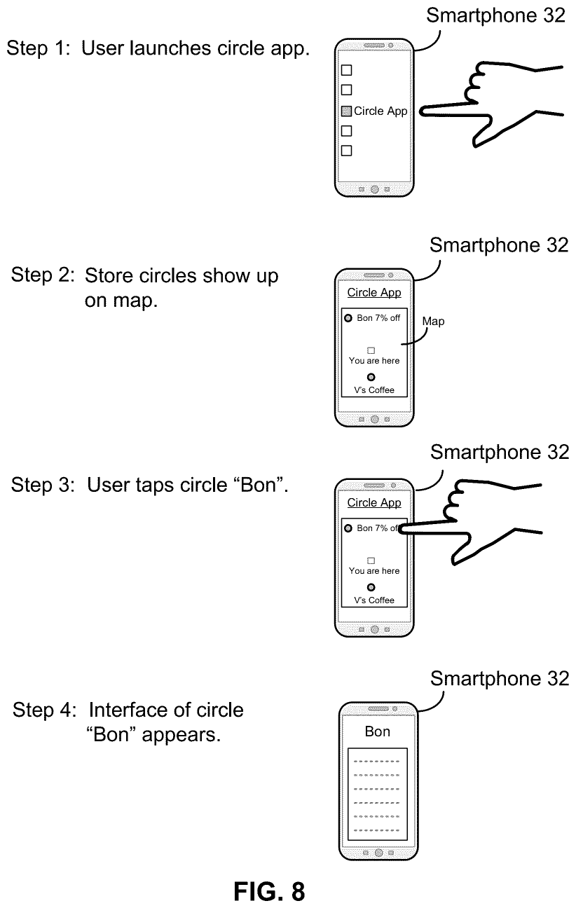

As illustrated above, a number of circle icons are arranged in an app interface, where each circle icon may contain a circle name and a short ad message in a single line. As the icon space is limited, the short ad message may only contain limited content items, such as a price cut or promotion. However, when a user looks for a deal, the user may want to know more besides pricing info. Thus another option may be arranged which allows each circle to present more content items in an app interface. As shown in FIG. 9 for instance, an app interface is shown on a screen 36 of a device 34. Circles “Good Mart” and “Shoe Store” are presented with multiple lines in icons 38 and 40 in a text mode. The first line of the icon may show a short ad message as depicted before. The second line or second and third lines may display the product brand, quality, origin, etc. For instance, icon 38 shows that the cherry is produced at North Farm and has the three-star quality, while icon 40 shows that the discount applies to all brands and all products are made in Napa with the four-star quality. Comparing to FIG. 4 where icons 28 and 30 are displayed, icons 38 and 40 in FIG. 9 present more detail. For switching between the single-line and multiple-line style, buttons “Product Info” or “Single Line” may be configured in an app interface. Optionally, a “Single Line” button 42 may be arranged. When button 42 is tapped, the format is switched to the single-line version which may look like what is shown in FIG. 4. Vice versa, when the “Product Info” button is tapped in an interface showing single-line icons, each icon may be replaced by a new one having multi-line content.

After data is entered in a store circle by a store clerk, the data is sent to service center automatically by the algorithm of a circle app. The data is then stored at product database by service center. After the data is in place at product database, it becomes searchable and available to all users. Therefore, a store circle interface may function as a data feeding platform as well as an advertising platform to show products, services, and events to all users. When a user needs to know something, the user may open a circle app, key in query words, get a search result from service center, and then find more info via a circle interface.

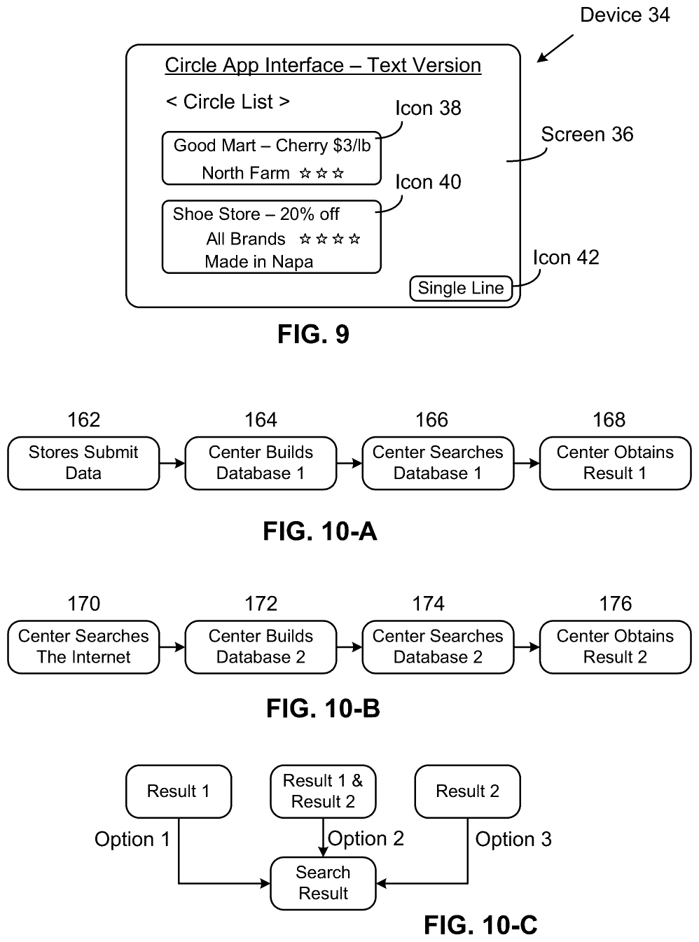

FIG. 10-A shows a schematic flow diagram which describes a search method. It starts from Step 162 where store clerks submit data such as product info and short ad messages via a circle interface respectively. The data is then transmitted to service center which uses it to build Database 1 at Step 164. Database 1 only contains data collected from the store circles or circle interfaces. After service center receives a search query from a user, it conducts a search at Database 1 at Step 166. Next at Step 168, Search Result 1 is obtained based on the search at Database 1. Since the search is performed at Database 1 where data is gathered from store circles under the supervision of service center, it may be considered as an internal search using the internal data. In comparison, FIG. 10-B shows a schematic flow diagram of another kind of search process. It begins from searching info on the Internet at Step 170, which involves mature and conventional methods as demonstrated by search engines employed at some well-known websites. Next at Step 172, service center compiles data to build Database 2. After a user hands in a search query, service center searches Database 2 at Step 174. Then, Search Result 2 is generated at Step 176. Result 2 is obtained from searching data at Database 2 and thus is based on info collected from sources on the Internet. FIG. 10-C shows exemplarily three ways to generate a search result. In Option 1, it may be designed that a search result only contains Result 1, i.e., info based on the store circles only. In Option 2, a search result contains both Result 1 and Result 2, a combination of the internal search and Internet search. In Option 3, a search result contains Result 2 only, i.e., a conventional result. Options, represented by check boxes, may be configured in an app interface so that a user may check a box to select among the three choices when conducting a search. Options may be provided so that a user may enter new conditions to adjust a search, such as narrowing a search result.

Optionally, when a search is carried out, Result 1 may be presented at a user device at first. If a user wants to know more, the user may tap an “Add Internet Data” button. Next, Result 2 may be obtained, combined with Result 1, and presented on screen. For instance, assume that Result 1 contains a list of five lines of store circles. Initially, there are five lines on screen after a search process is completed. Then a user taps “Add internet Data” button. Next, Result 1 and Result 2 are presented on screen together, with the latter following the former and starting from the sixth line. It may provide convenience when more info is desired. In case Result 1 contains a long list, Result 2 may be added after a given line, or part of Result 2 may be inserted between two given consecutive lines of Result 1. When a circle interface presents both Result 1 and 2, two buttons “Circle Info Only” and “Internet Only” may be arranged in the app interface. A user may tap a button to view results from one source only.

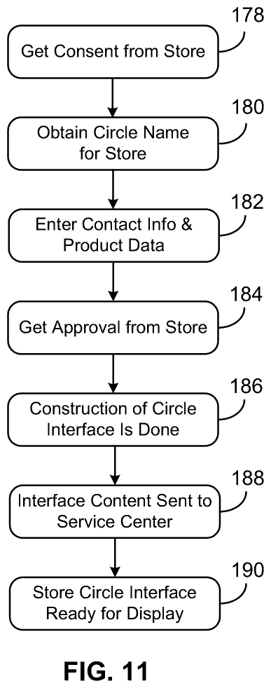

For some stores, setting up a store circle interface may look intimidating due to lack of knowledge and skills. Thus, there exists a need to assist stores to build a circle interface. FIG. 11 shows a flow diagram to describe schematically a process to help a store create a circle interface. At Step 178, a representative of service center may contact the store clerk, invite the store to join a circle plan, and get consent to build a circle interface for the store. First, the representative may create a circle name for the store at Step 180. A circle name may be arranged to be the store name if it's distinctive enough and not very long. Otherwise, a circle name may be created. It may contain some elements which are related to the store name. An ideal circle name is what users may easily recognize and relate to a store.

Next at Step 182, the representative may install a circle app at a store device. Service center may design two kinds of the circle app, one for regular people and the other for stores or businesses. A circle app for store use enables a store to input and edit interface content items after login of the store account. When the app installation is completed, the representative may key in or upload data to generate contact info and construct a product showcase. If a store doesn't want to have a product showcase, the step may only contain input of the contact info. When uploading data, a representative may use the circle app to search and get info from electronic files provided by the store or get info from the store's website. Then the representative may show a finished circle interface to and get it approved by the store clerk at Step 184. Once an approval is obtained from the store, the construction of the circle interface is completed as at Step 186. Next, content items of the circle interface are transmitted to service center by the circle app at Step 188. After service center receives data from the store, it keeps it at product database. Finally, the store circle interface becomes ready for display and public use at Step 190.

Optionally, a store circle interface may be replaced by a store's website, i.e., after a user taps a circle icon in a circle app interface, a screen may show a store's existing webpage, instead of a circle interface provided by service center. Certain stores may prefer such an arrangement as it may save cost on content management. To accommodate such cases, for instance, a button “Webpage as Interface” may be configured in a store circle interface. A small space may be configured beside the button for entering the address of a selected webpage. After the button is tapped, a message may be sent to service center so that users may be directed to the selected webpage. As such, a store circle interface may become simplified, as there is no need to display content items that need constant attention and frequent update. The interface may display an image of the selected webpage as a reminder for a store clerk. Since a regular webpage may not provide a short ad message for the app interface, the small ad window may remain in the circle interface for the purpose of submitting a short ad message for the app interface. Optionally, a button “Cancel Webpage Show”, may be arranged in the circle interface. A store clerk may tap the button to cancel the connection between a circle icon in an app interface and a webpage. Once the button is activated, users are directed to the store circle interface.

In some embodiments, “Order” buttons may be configured in a circle app interface, such as those shown in FIGS. 3-4 and 9. The “Order” button may be proximate to a circle icon (e.g., icon 24 or 26) and arranged for users who want to place an order to purchase products presented in a store circle. When a circle app detects that the “Order” button is activated, it presents a new page or a window in the circle app interface, where a user may select product items and complete a purchase process.

When an ad of a local store is shown to a user sitting in a vehicle, the user may want to go to the store if some products in the ad seem attractive. Hence, there exists a need to provide an option to drive a user to a business when an ad of the business is presented to the user.

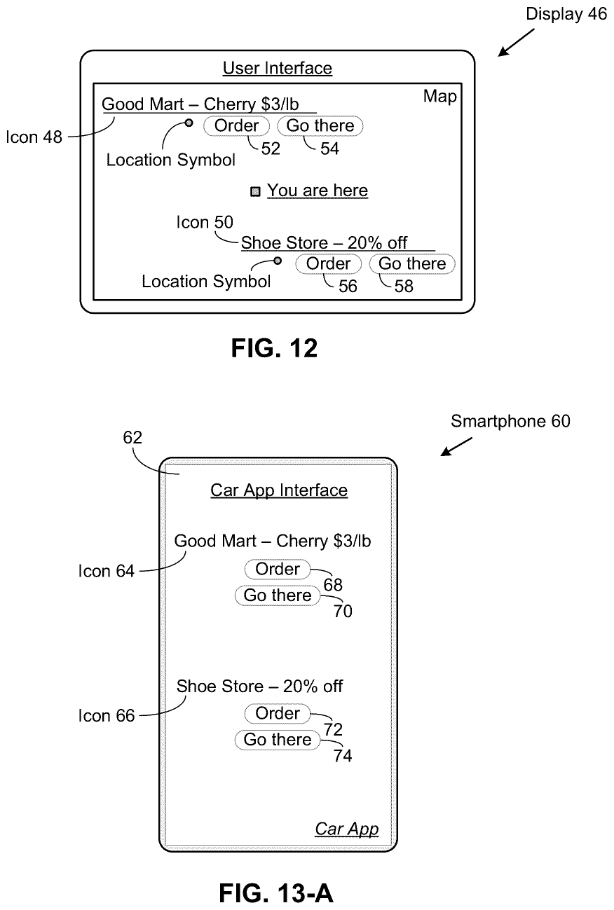

FIG. 12 schematically shows a user interface on a touch-sensitive screen of a display 46 inside a vehicle (not shown). The vehicle may be a driver-operated vehicle or an autonomous vehicle (also known as a driverless or self-driving vehicle). The vehicle may include an automobile, an aircraft, a flying car, a ship, or a motorcycle. In descriptions below, an autonomous automobile is used as an example for the vehicle.

The vehicle, as an autonomous automobile, may include a vehicle control system and a driving system responsible for vehicle navigation and driving, respectively. The control system may include a processor and a computer readable medium. The processor may run programs or sets of executable instructions stored in the computer readable medium for performing various functions and tasks, e.g., receiving and processing data collected from sensors, communicating with service center, retrieving map data from the medium or service center, sending driving signals to the driving system, monitoring and interacting with a user inside the vehicle, executing other applications, etc. The control system may also include input, output, and communication components.

The control system manages and controls display 46, which is used to show the vehicle status, a current destination, a current driving route, certain options for a user, etc. A user may use the user interface to review a command issued by the user, search and retrieve information, view maps of surrounding areas, interact with the control system, and conduct other actions. The driving system may include a speed module, a steering module, a braking module, and so on for implementing driving maneuvers which are determined by the control system. The vehicle may also include various sensors such as cameras, microphones, a radar system, a light detection and ranging (LIDAR) system, a GPS device, a speed sensor, an accelerometer, an electronic compass, and a suspension sensor. The sensors are installed on the exterior of or inside the vehicle.

After a user gets in the vehicle, the control system may start monitoring the user or an action of the user using sensors such as a camera, a microphone, or the user interface of the control system. For example, the control system may monitor or detect whether the user performs an action, such as tapping an icon or keying in a word in the user interface, uttering a voice command, or making a gesture as a command. The control system may show content items such as ads in the user interface as illustrated exemplarily in FIG. 12. The ads may be presented in a map mode in a similar way to that shown in FIG. 3. For example, interactive icons 48 and 50 representing store circles Good Mart and Shoe Store are displayed. The store locations are also displayed on the map. Icons 48 and 50 may each contain a name or a name and a short ad message. In the latter case, the name and short ad message are proximate to each other and form an icon together. Similar to icons 24-30 as shown in FIGS. 3-4, after a user taps icon 48 (or 50), a window or page may appear in the user interface that contains content items prepared by Good Mart (or Shoe Store). Other buttons and functions, such as those illustrated in a circle app interface, may also be arranged in the user interface of FIG. 12, which may facilitate, e.g., multi-line presentation, searching for products, switching to text format, etc.

Beneath icons 48 and 50 and proximate to the icons respectively, interactive buttons 52, 54, 56, and 58 are configured, respectively. For example, buttons 52 and 54 may be proximate to the name of a business (e.g., Good Mart) or the short ad message of the business. The icons and buttons are graphic objects displayed in the user interface. Buttons 52 and 56 are exemplary “Order” buttons. Buttons 54 and 58 are exemplary “Go there” buttons. After the “Order” button is tapped, a new page or window shows up displaying content items for a purchase process. Then, the user may place an order and request a product to be shipped to a place. In some cases, the user in the vehicle may also order a product and request a business to deliver the product to the vehicle. Optionally, the word “Order” as the exemplary content of the label for buttons 52 and 56 may be replaced by, e.g., “Place Order” or “Purchase”.

Since Good Mart and Shoe Store are local as shown on the map, if the user wants to go to the store to take a look, the user may tap “Go there” button 54 or 58. For the convenience to use the function, the label of buttons 54 and 58 may show a message that indicates a command to go to a place. For example, “Go there” or “Drive there” may reflect such a command and be used as the content of the label. In some cases, after the control system detects that button 54 is activated, the control system considers activation of the button as an order from a user and may present a message such as “Drive to Good Mart now?” in the user interface. The message is arranged to ask the user to confirm or acknowledge a location of Good Mart is the destination. The user may confirm by tapping a “Yes” button (not shown) configured in the user interface. After the control system detects activation of the “Yes” button, it may determine that the destination is confirmed and it is Good Mart. The control system may use Good Mart to replace an old address. If the control system does not have any destination info yet, Good Mart becomes the destination.

Alternatively, the user may also utter “Yes” to confirm a destination. The control system may receive the utterance “Yes” via a microphone and obtain the message using a voice recognition mechanism. Alternatively, the user may utter a command such as “Go to Good Mart”, instead of tapping button 54. The control system may consider such a voice command equals to activation of button 54 and subsequently ask for confirmation. If no response is detected from the user within a given short time period, such as five seconds, the control system may consider that the answer is yes. After a confirmation answer is received from the user, the control system determines that Good Mart is the destination, calculates a route, sends navigation signals to the driving system, and drives the vehicle to Good Mart autonomously.

Ads such as that shown in FIG. 12 may be presented to a user at the beginning of a trip or during a trip. Once a user taps a button (e.g., button 54 or 58) to request to go to a destination or a new destination, the control system may take it or accept the change and then calculate a route to the destination accordingly. If a user hails a vehicle without providing destination info, a control system of the vehicle may wait and decide a destination after the user enters the vehicle. The user may utter a place as a destination or choose a place after viewing store circles presented in a user interface by, e.g., tapping a “Go there” button.

When a vehicle is operated by a driver, there is no need for a control system to navigate the vehicle. In such cases, a subsystem with a processor may be arranged in the vehicle. The subsystem may control and monitor a display (e.g., display 46 of FIG. 12) and a screen facing the driver seat. After store circles are presented in a user interface of the display, activation of certain button (e.g., a “Go there” button) by a user may cause the subsystem to request confirmation of a destination, determine the destination after obtaining a confirmation, and calculate a route to the destination. Then, the subsystem may present a destination notification, a name of the destination, and the route on the screen facing the driver of the vehicle. The driver then may follow the route and drive the user to the just-determined destination.

When a user hails a vehicle via service center frequently or regularly, service center may collect and store user information of the user. The user information may include ride records of the user, such as past pick-up places, pick-up times, routes, and destinations. The user information may also include summaries and certain daily or weekly patterns that are made based on the ride records.

Before or after a user gets in a vehicle, a control system of the vehicle may recognize or identify the user by an identification method such as facial recognition, fingerprint, or scanning an ID card, a credit card, or a membership card. Thereafter, the control system may send the user identification info to service center. Service center then retrieves user information of the user and selects some store circles based on the user information and the location of the vehicle. For example, the select store circles may include stores that the user visited more often than other stores within a certain geographic range in a given time period, and stores that are close to certain destinations where the user often went. Next, service center sends data of the select store circles to the vehicle. After the control system obtains the data from service center, it displays the select store circles in the user interface. Alternatively, the control system may fetch the user information from service center after identifying the user, and then select and display store circles based on the user information and location data.

In some cases, when the control system detects that a user utters one or more words, the control system may treat it as a command from the user. For example, after the control system receives a voice input from the user via a microphone, the control system interprets it using a voice recognition mechanism. If the voice input contains one or more words, the control system may detect whether the one or more words match a name of product in records. After it is determined that the one or more words match a name of a product, the control system may ascertain which stores carry the product within a geographic range, and from the stores, select those that the user frequented within a given time period. Then, the control system displays store circles of the select stores in the user interface. The user may tap an “Order” button to choose a store circle and place an order, or tap a “Go there” button to request the vehicle to drive to a store.

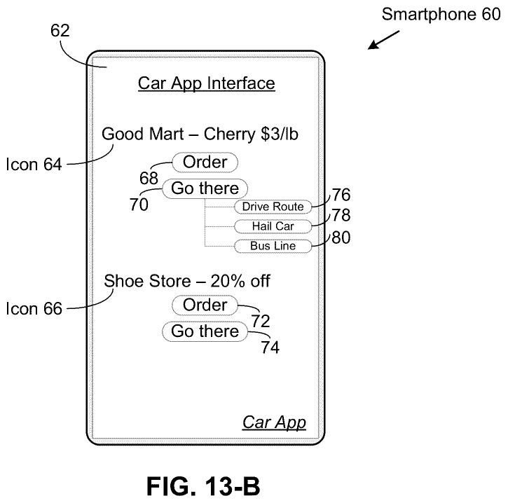

FIG. 13-A schematically shows an app interface at a smartphone 60. Smartphone 60 has a touch-sensitive screen 62 that displays the app interface. An app, such as Car App, is installed at smartphone 60, which may be used by a user to hail a vehicle via service center. Assume that the phone's positioning function is enabled. The current location of smartphone 60 may be considered as a potential pick-up place by service center. With Car App, the user may enter a name of a place as a destination and tap a button to hail a vehicle from service center.

After getting in a vehicle, the user may open Car App and take a look at the app interface. Meanwhile, Car App may communicate with a control system of the vehicle and the control system may identify the user based on, for example, an account number of the user via Car App. The control system may facilitate Car App to display content items as shown exemplarily in FIG. 13-A. Car App may monitor actions of the user via the app interface, such as whether the user taps an object in the app interface. Car App may also monitor the user via a microphone mounted on smartphone 60 and receive a voice input from the user. In the app interface, interactive icons 64 and 66 and interactive buttons 68, 70, 72, and 74 are presented. The icons and buttons as shown in FIGS. 12 and 13-A may have the same function and property and the same or similar appearance, while the former is presented in a map mode and the latter is in a text mode. Hence, similar to buttons 52 and 56 as shown in FIG. 12, buttons 68 and 72 are “Order” buttons for assisting the user to place an order for products provided by a business. Similar to buttons 54 and 58, buttons 70 and 74 are “Go there” buttons for assisting the user to issue a command to drive the vehicle to a place, e.g., Good Mart or Shoe Store. Further, the “Order” and “Go there” buttons (e.g., buttons 68 and 70) may be placed proximate or adjacent to a store circle icon (e.g., icon 64). That is, the “Order” and “Go there” buttons are proximate to and displayed together with a name of a store circle (or store) or a short ad message from a store.

After store circles are presented in the app interface of smartphone 60, Car App keeps communicating with the control system of the vehicle. Car App and the control system may be connected directly or via service center using suitable communication techniques. Meanwhile, Car App monitors whether any graphic object (e.g., an interactive icon or button) is tapped by the user and whether the user utters a voice command via sensors of smartphone 60. In some cases, after Car App obtains info that button 70 is activated, Car App may treat activation of button 70 as a request from the user and show a confirmation question such as “Go to Good Mart?” in the app interface. The question asks the user to confirm or acknowledge Good Mart becomes the current destination. The user may confirm by tapping a “Yes” button (not shown) configured in the app interface. After Car App obtains that the “Yes” button is tapped, Car App passes the information to the control system of the vehicle. The control system may use Good Mart as the destination or use it to replace an old destination. In some cases, when Car App presents store circles in the app interface at smartphone 60, the control system of the vehicle may present the same store circles in the same mode (i.e., the map or text mode) with the same or similar configuration simultaneously on a touch-sensitive screen mounted inside the vehicle. As such, the user may interact with the control system of the vehicle through either smartphone 60 or the touch-sensitive screen anytime.

Alternatively, the user may also utter an answer such as “Yes” as a confirmation answer to smartphone 60, which may receive the verbal input via a microphone, obtain the answer using a voice recognition mechanism, and then pass the answer to Car App. If no response is detected from the user within a given short time period after posting the confirmation request, such as five seconds, Car App and the control system may consider that the answer is yes. After a confirmation answer is received from the user, the control system may determine that Good Mart is the current destination, calculate a route, send instructions to the driving system of the vehicle, and navigate the vehicle to Good Mart autonomously.

As the user is identified, the control system may obtain user information of the user from service center. The control system or service center may select certain store circles based on the user information. In the latter case, the control system receives the select store circles from service center. Then the control system presents these store circles in the app interface. Similar to that illustrated above, if a select store circle has submitted a short ad message to service center, the short ad message may be presented in the app interface. The selection method for the store circles may be the same as or similar to that illustrated above.

When Car App receives a voice input from the user, it may transfer the message to the control system of the vehicle. Optionally, when both Car App and the control system obtain a voice input from the user at the same time, the voice input obtained by Car App may prevail. In similar ways to that described above, when the control system detects that the message (from the voice input) contains one or more words that match a name of a product, the control system may find candidate stores that carry the product based on the location of the vehicle. Then the control system may select from the candidate stores and choose some stores that the user frequented within a given time based on the user information. Thereafter, the control system may retrieve data of the select stores from service center and pass the data to smartphone 60. The phone then displays store circles of the select stores in the app interface. The user may tap an “Order” button to start a purchase process in a store circle, or tap a “Go there” button to request the vehicle to drive to a store.

The user information of a user may be stored at service center and/or a user device (e.g., a smartphone) of the user. Because the user information contains sensitive personal data, such as where and when a user went in the past, some users may want to keep the user information at their own devices to protect privacy, instead of at database of service center. Optionally, a user may require the user information to be kept at a designated user device (e.g., smartphone 60) only. For example, Car App may include a setup procedure that enables a user to choose a personal device to keep the user information. As such, after a control system of a vehicle and service center collect and analyze relevant personal information of the user, they only store the user information at the personal device (e.g., smartphone 60). In some cases, once the user uses Car App to log in a control system of a vehicle after getting in the vehicle, the control system may retrieve a copy of the user information stored at smartphone 60 and keep it temporarily. In some cases, the copy of the user information only contains a predetermined portion of the user information. The control system may select stores based on the user information obtained. Optionally, the control system may send the copy of the user information to service center such that service center may select stores for the user based on the user information as well.

Alternatively, after a user gets in a vehicle and uses Car App to log in a control system of the vehicle, service center may retrieve a copy of the user information stored at smartphone 60 and keep it temporarily. The copy of the user information may contain all or a certain part of the user information stored at smartphone 60. For example, the certain part of the user information may only contain data collected within a certain time frame. Service center may select stores based on the copy of the user information and the location of the vehicle. Optionally, service center may send the copy of the user information to the control system of the vehicle such that the control system may also select stores for the user based on the user information.

After the user leaves the vehicle at a destination, the control system may send a trip report about the user to service center. Either the control system or service center may update the user information after a trip is concluded. Thereafter, service center may communicate with smartphone 60 at a certain point, transmit updated content of the user information to Car App, and request Car App to update the user information and store the updated user information at smartphone 60. At certain points, the control system and service center each may delete or discard the user information they obtained and kept temporarily. As such, the control system and service no longer have the user information at the vehicle or service center shortly after Car App makes the update.

In some embodiments, the positioning function of smartphone 60 is enabled. After Car App is launched at smartphone 60, Car App and service center may obtain location data of the user. Service center may analyze the location data to ascertain where the user is, e.g., at home, in a building, or inside a store. When the user's position keeps changing, service center may analyze the user's location data and motion patterns such as speeds, acceleration, and deceleration of a motion. Then, service center may detect whether the user is moving fast down a road or along a route of public transportation (e.g., a bus, subway, train, or ferry). Thereafter, service center may determine whether the user is in a vehicle not controlled by service center, or for example, on a bus moving along a bus route. Optionally, Car App may get the analysis results from service center or perform similar calculation tasks to obtain the analysis results.

When the user is at a place such as at home or in the office and opens Car App at smartphone 60, the user may hail a car and check what is on sale locally. Assume Car App already knows the location of the user (e.g., at home). Car App may display an interface the same as or similar to that illustrated in FIG. 13-A, where certain businesses, e.g., Good Mart and Shoe Store, are presented with short messages. As described above, the user may tap icon 64 or 66 to get more information. The user may also tap button 68 or 72 to place a purchase order. As the user is at a place away from a vehicle, Car App may assign certain functions to buttons 70 and 74 to assist the user to go to either store. In such cases, besides the label “Go there”, labels of buttons 70 and 74 may also be “Get there” exemplarily. As shown in FIG. 13-B, after detecting button 70 is tapped, Car App presents button 76, 78, and 80 that are configured proximate or adjacent to button 70 in response. Alternatively, buttons 76-80 may be displayed along with button 70 automatically. That is, buttons 76-80 may appear with other buttons automatically when the interface as shown in FIG. 13-A or 13-B is presented. With the same manner, additional buttons similar to buttons 76-80 may be configured and shown adjacent to button 74 automatically in some cases. As actual driving maneuvers are not involved, Car App does not ask for confirmation after any of buttons 76-80 is tapped. Buttons 76-80 have exemplary labels, such as “Drive Route”, “Hail Car”, and “Bus Line”, providing the user with three options.

After Car App detects button 76 is tapped by the user, it presents a driving route on screen 62. The driving route, generated by Car App or service center, is a route for driving from the current location of the user to Good Mart. After Car App detects button 78 is activated (e.g., by tapping), it displays a vehicle-hailing page. On the vehicle-hailing page, the user's current location (or a nearby suitable location) may be selected as a default pickup place, and Good Mart as a default destination. The user may change the default settings, while inputting other information such as a pickup time and vehicle preference. After Car App detects button 80 is activated, it presents one or more bus routes and/or subway lines on screen 62. The bus route connects a bus stop near the current location to another bus stop close to Good Mart. The user may take bus (or subway) to go to Good Mart. Hence, Car App may provide several options for the user to get to a business that shows up in the interface, when the user is at a place and not in a vehicle.

Besides a smartphone, the above-illustrated methods with respect to FIG. 13-B may also be applied to a desktop computer, laptop computer, or tablet computer that is at a place (e.g., at home or in the office). Assume Car App (or certain software with similar functions) is installed at the computer, and knows the approximate location of the computer. A user may open Car App at the computer, and check what is on sale locally. In such cases, icons and buttons 64-80 may be shown on a display screen of the computer in a similar way to that as shown in FIG. 13-B in a text mode. The interface in a map mode may be similar to that shown in FIG. 12. In the text mode for example, after button 70 is activated (e.g., by clicking or tapping), buttons 76-80 appear like that shown in FIG. 13-B. The user may then activate one of buttons 76-80 to get a driving route, hail a car, or obtain a bus route in similar manners to that described above. The starting point of the driving route may be the approximate location and the user may change it to another location when needed. The default pickup place for hailing is at or near the approximate location, while the user may input another location as the pickup location. The bus route may connect a bus stop around the approximate location to Good Mart.

When the user is on a bus or the subway and opens Car App at smartphone 60, the user may also hail a car or check what is on sale locally. Assume Car App already knows the user is on a bus. Car App may display an interface similar to that illustrated in FIG. 13-A, where certain businesses, e.g., Good Mart and Shoe Store, are presented with short messages. As described above, the user may tap button 68 or 72 to place a purchase order. As the user is on the bus, Car App may assign certain functions to buttons 70 and 74 to assist the user to go to either store. In such cases, besides “Go there”, labels of buttons 70 and 74 may also be “Get there” exemplarily. Optionally, after Car App detects button 70 is tapped, it may in response present two graphic objects that are the same as or similar to buttons 78 and 80 as shown in FIG. 13-B in terms of the appearance and functions. Assume the two buttons are still called buttons 78 and 80. As driving maneuvers are not involved, Car App does not ask for confirmation after buttons 78 and 80 are activated. Buttons 78 and 80 may be configured proximate to or beside button 70 with exemplary labels, such as “Hail Car” and “Bus Line”, respectively. Similar to that described above, button 78 leads to a vehicle-hailing interface that provides an option for the user to hail a car, while button 80 leads to an interface displaying bus routes that provide an option for the user to take bus to go to Good Mart. When the user hails a car on the bus, the default destination is Good Mart, while the default pickup locations may be a number of bus stops. The user may choose one of the bus stops as the pickup location. After button 80 is tapped, bus routes may appear that connect select bus stops to a place near Good Mart, respectively.

Assume the user is in a car that is not managed by service center. The car is running down the road. The user may hail a vehicle and check what is on sale locally using Car App and smartphone 60 (or a computer mounted in the car). Also assume Car App is launched at smartphone 60 (or the computer) and already knows the user is in the car. Car App may display an interface similar to that illustrated in FIG. 13-A, where certain businesses, e.g., Good Mart and Shoe Store, are presented with short messages. As described above, the user may tap button 68 or 72 to place a purchase order. As the user is in the car, Car App may assign certain functions to buttons 70 and 74 to assist the user to go to either store. Optionally, besides “Go there”, labels of buttons 70 and 74 may also be “Get there” exemplarily. In some cases, in response to activation of button 70, Car App may present buttons 76, 78, and 80 with similar manners to that described above and shown in FIG. 13-B. The appearance, locations, and functions of buttons 76-80 may be the same as or similar to that illustrated above. For example, buttons 76, 78, and 80 may be configured proximate or adjacent to button 70 with exemplary labels, such as “Drive Route”, “Hail Car”, and “Bus Line”, respectively. As described above, button 76 may lead to an interface showing a driving route to assist the user to go from the current location to Good Mart, button 78 may lead to a vehicle-hailing interface that provides an option for the user to hail a vehicle, and button 80 may lead to an interface with bus routes that provide options for the user to take bus to head for Good Mart. When the user hails a vehicle in the car, the default destination is Good Mart, while the user has to submit a pickup location besides entering a pickup time and other information. The bus routes may connect nearby bus stops to a place close to Good Mart, respectively.

Optionally, a space (or button) with an exemplary label “destination” may be configured in an interface of Car App. A user may use the space (or button) to enter an address or a name of a location, business, or organization as a destination. The user may key in the address information in the space or tap the button to get an input space where the address information may be entered. In some cases, the interface may be similar to that shown in FIGS. 12, 13-A, and 13-B. After the address information is entered at least partially, a button with a label like “Go there” may show up adjacent to the space. The button may have an appearance and functions similar to that of buttons 54 and 70. Assume the user is in a vehicle dispatched and managed by service center. The user may activate the button to request the vehicle to navigate to the inputted destination in a similar way to that described above. When the user is at a place, on a bus, or in a vehicle not managed by service center, buttons like button 76, 78, and/or 80 may appear adjacent to the space in the interface after the address information is entered at least partially. The user may select one of the buttons to get a drive route, hail a car, or get a bus route for going to the destination. Thus, besides entities (e.g., stores) presented with an ad message in a Car App interface, a user may also input a destination. Car App may present buttons (e.g., buttons 70, 76-80) in the interface with similar methods and similar manners to that illustrated above, providing options to assist the user to go to the destination conveniently. With the options, the user may request a vehicle to drive to the destination, or receive a driving route, hail a vehicle, or obtain a bus route to get there.

In some aspects, when services of public transportation are limited in an area, Car App may not provide options like bus routes for a user to go to a place. In such cases, button 80 as shown in FIG. 13-B may be removed from the interface.

### CONCLUSION, RAMIFICATIONS, AND SCOPE

Thus it can be seen that systems and methods are introduced to provide improved advertisement with a short message and driving instructions.

The improved method and system have the following features and advantages:
(1). Location-based store circles are arranged for businesses;
(2). Ads with a short message from nearby businesses are presented in an app interface;
(3). An ad contains a name of a business and a short message;
(4). An ad contains a name of a business, a short message, and a button for place an order; and
(5). An ad presented inside a vehicle contains a name of a business, a short message, and a button for asking the vehicle to drive to the business.

Although the description above contains many specificities, these should not be construed as limiting the scope of the invention but as merely providing illustrations of some of the presently preferred embodiments. Numerous modifications will be obvious to those skilled in the art.

### Ramifications

A user may speak to a device to enter instructions using voice recognition techniques. Optionally, after a user arrives at a place, the user may say “circle app” to a device to launch a circle program. Next a circle app interface may show up on screen with icons of store circles presented. The user may take a look at the icons and say a circle's name to enter it.

Besides businesses and organizations, an individual user may also file application at service center to set up a networking circle. A circle may be arranged for personal use.

As illustrated above, a store clerk may tap “Edit” button to enter “Edit” mode in a circle interface. Then the clerk may enter “Data Entry” section by activating a “Data Entry” icon. In the section, a data input form may be arranged that provides convenience for keying in data. The data may be related to products, services, events, etc. As businesses and organizations may have their unique requirements, there exists a need to prepare different data input forms accordingly. For instance, forms may be generated exclusively for a retail store, an online store, a restaurant, a transportation company, a private or public venue, a manufacturer, a service, a service provider, a government agency, and so on. For a restaurant, a product name may be a dish name or a name of a menu item. For a service provider, a program name or service name becomes a product name. For a hotel, product names are of various rooms available. For websites selling airline tickets, product names may reflect tickets from a place to another place.

Sometimes users may prefer shopping online without physically visiting a retail store. As a result, some retail stores may arrange online purchase function in a circle interface. Online transaction and payment technologies are mature and widely used at many websites. It may be designed that for store circles providing online purchase function, a label with words like “Online Order” may be attached to a circle icon. Hence, users may easily tell which circle handles online transactions. For users interested in online stores, “Online Store Only” button may be arranged. Once tapped, only online shops are presented.

Since some stores have online ordering capability and some don't, an “Online Order Only” button may be arranged in a circle app interface. A user may activate it to remove store circles which don't offer online ordering. Thus an app interface may be arranged to only display store circles which have the capacity. Additionally, a “Default Config” button may be arranged in an app interface for returning to a screen view of a default configuration.

In a circle app interface, a circle icon may show a short ad message. But sometimes, an image may enhance ad effect. As such, a specific small button may be arranged beside a circle icon. Once the button is tapped, an ad image may show up. The image may be big enough to display certain detail of a product, say as big as a quarter or half of the screen size. In order to upload image data, a file button may be arranged beside the small ad window in a circle interface. A store clerk may tap the file button to start finding and uploading image data.

In above descriptions, “tap” as a verb is used as an action to activate an interactive icon or button on screen. It is noted that the tapping action may be replaced by other suitable moves, such as clicking, verbal instructions, or gesture instructions. Verbal and gesture instructions may play an important role when VR and AR devices are involved. For instance, a user may verbally ask a VR or AR device to start a circle app, show store circles nearby, display a circle interface, or request a vehicle to go to a store with mature voice recognition technology.

All descriptions in regard to an app interface may be configured in both map mode and text modes without specific mentioning in many cases, as the main difference between them is of presentation style.

When selecting store circles for presentation in an interface for a user, a control system of a vehicle or service center may use other information besides the location data and user information of the user. For example, when it is detected that the user utters “Coffee”, the control system or service center may choose some coffee shops based on the user information, choose some other coffee shops based on the popularity of the coffee shops (e.g., shops that have more customers than others), and then present the select coffee shops to the user together.

Lastly, in aforementioned descriptions, QR codes may be replaced by other machine readable codes without affecting proposed functionality, such as one-dimensional bar codes, as long as the codes contain info required and are readable by a device.

Therefore the scope of the invention should be determined by the appended claims and their legal equivalents, rather than by the examples given.

1. A method performed in a vehicle, comprising:
1) monitoring a user or an action of the user after the user enters the vehicle using one or more sensors;
2) presenting a name of an entity and an advertisement message on a screen of a display mounted inside the vehicle;
3) presenting a graphic object together with the name of the entity and the advertisement message on the screen, the graphic object being interactive and configured for the user to submit a request or order to arrange the vehicle to go to a place of the entity;
4) in response to activation of the graphic object by the user, presenting a confirmation message that asks the user to confirm or acknowledge that the place of the entity is a destination; and
5) driving the vehicle to the destination.

2. The method according to claim 1 wherein the advertisement message is an advertisement of the entity.

3. The method according to claim 1 further including, presenting an interactive icon on the screen, wherein the interactive icon displays the name of the entity and the advertisement message, and after the interactive icon is activated, information with regard to the entity is presented on the screen.

4. The method according to claim 1 further including, presenting an interactive button on the screen, the interactive button arranged for assisting the user to purchase a product from the entity.

5. The method according to claim 1 wherein the entity is selected based on user information of the user.

6. The method according to claim 1 further including, in response to reception of a voice input from the user, presenting the confirmation message on the screen.

7. The method according to claim 1 further including, after receiving an input that confirms or acknowledges the destination, driving the vehicle to the destination.

8. A method performed at a device of a user, comprising:
1) communicating with a control system of a vehicle, the user being inside the vehicle;
2) monitoring a user action performed by the user using one or more sensors;
3) presenting a name of an entity and an advertisement message in an interface of the device;
4) presenting a graphic object together with the name of the entity and the advertisement message in the interface, the graphic object being interactive and configured for the user to submit a request or order to arrange the vehicle to go to a place of the entity;
5) in response to activation of the graphic object by the user, presenting a confirmation message that asks the user to confirm or acknowledge that the place of the entity is a destination for a trip; and
6) transmitting a driving message to the control system, wherein the driving message requests the vehicle to go to the destination.

9. The method according to claim 8 wherein the advertisement message is an advertisement of the entity.

10. The method according to claim 8 wherein an interactive icon is configured in the interface that displays the name of the entity and the advertisement message, and after the icon is activated, information with regard to the entity is presented in the interface.

11. The method according to claim 8 further including, presenting an interactive button in the interface, the interactive button arranged for assisting the user to purchase a product from the entity.

12. The method according to claim 8 wherein the entity is selected based on user information of the user.

13. The method according to claim 8 further including, in response to reception of a voice input from the user, presenting the confirmation message in the interface.

14. The method according to claim 8 further including, after receiving an input that confirms or acknowledges the destination, transmitting the driving message to the control system.

15. A vehicle comprising:
a plurality of sensors;
a driving system; and
a control system including a processor and a memory or memory unit, the control system configured to:
1) monitor a user or an action of the user after the user enters the vehicle using one or more of the plurality of sensors;
2.) present a name of an entity and an advertisement message on a screen of a display mounted inside the vehicle;
3) present a graphic object together with the name of the entity and the advertisement message on the screen, the graphic object being interactive and configured for the user to submit a request or order to arrange the vehicle to go to a place of the entity;
4) in response to activation of the graphic object by the user, present a confirmation message that asks the user to confirm or acknowledge the place of the entity is a destination; and
5) transmit a navigation signal for driving the vehicle to the destination via the driving system.

16. The vehicle according to claim 15 wherein an interactive icon is configured on the screen that displays the name of the entity and the advertisement message, and after the icon is activated, information with regard to the entity is presented on the screen.

17. The vehicle according to claim 15 wherein the control system is further configured to present an interactive button, the interactive button arranged for assisting the user to purchase a product from the entity.

18. The vehicle according to claim 15 wherein the entity is selected based on user information of the user.

19. The vehicle according to claim 15 wherein the control system is further configured to present the confirmation message on the screen in response to reception of a voice input from the user.

20. The vehicle according to claim 15 wherein the control system is further configured to transmit the navigation signal for driving the vehicle to the destination after receiving an input that confirms or acknowledges the destination.
